(19) United States
(12) Patent Application Publication
(10) Pub. No.: US 2006/0163247 A1
(43) Pub. Date: Jul. 27, 2006

(54) Securement system for electrical wall box

(76) Inventor: Pat Bryant, Nampa, ID (US)

Correspondence Address: PEDERSEN & COMPANY, PLLC, P.O. BOX 2666, BOISE, ID, 83701, US

(21) Appl. No.: 11/045,884

(22) Filed: Jan. 27, 2005

(51) Int. Cl. H02G 3/08

(52) U.S. Cl. 220/3.2

(57) ABSTRACT

An electrical wall box is friction fitted into a masonry brick by driving screws through holes the left and right sides of the box at a preferred angle of thirty degrees from the normal to the sides. This angle allows the point of contact between the screws and the masonry brick to be far enough away from the face of the masonry brick to prevent chipping. Small apertures are drilled into the masonry brick at points of contact between the masonry brick and the screws on the left and right sides of the box. Screws may also be driven through holes in the top and bottom of the box to ensure proper vertical placement of the box. Set screws are preferred.

### BACKGROUND OF THE INVENTION

Electrical boxes must be installed flush with the face of masonry walls. When masons prepare walls for installation of electrical boxes, they must cut a hole in one of the blocks to accommodate the box. This hole must be the exact size of the box to prevent the box from coming loose after it is installed. This is because after the electrical boxes are installed, concrete is poured into vertical holes running through the blocks that stabilize the wall. As the concrete dries, it expands. If the hole was too large for the box, the box will be pushed forward and out of the wall.

In practice, if a mason cuts a hole for an electrical box which is too big for the electrical box, he must reduce the size of the hole by inserting cement, or close the hole entirely and cut a new hole. This results in a great loss of time to the mason.

### SUMMARY OF THE INVENTION

The present invention is an electrical box installed into a masonry brick with angled screws on driven through threaded holes on the left and right sides of the box pointing away from the face of the masonry brick.

### BRIEF DESCRIPTION OF THE DRAWINGS

FIG. 1 is a perspective view of the preferred embodiment of the invention as it is being secured into a masonry block with a screwdriver.

FIG. 2 is a front view of the embodiment of FIG. 1 as it is being secured into a masonry block with a screwdriver.

FIG. 3 is a perspective view of the embodiment of FIGS. 1-2 with one of the screws being adjusted with a screwdriver.

FIG. 4 is a front view of the embodiment of FIGS. 1-3.

FIG. 5 is a side view of the embodiment of FIGS. 1-4.

FIG. 6 is a top view of the embodiment of FIGS. 1-5.

FIG. 7 is a perspective view of the embodiment of FIGS. 1-6.

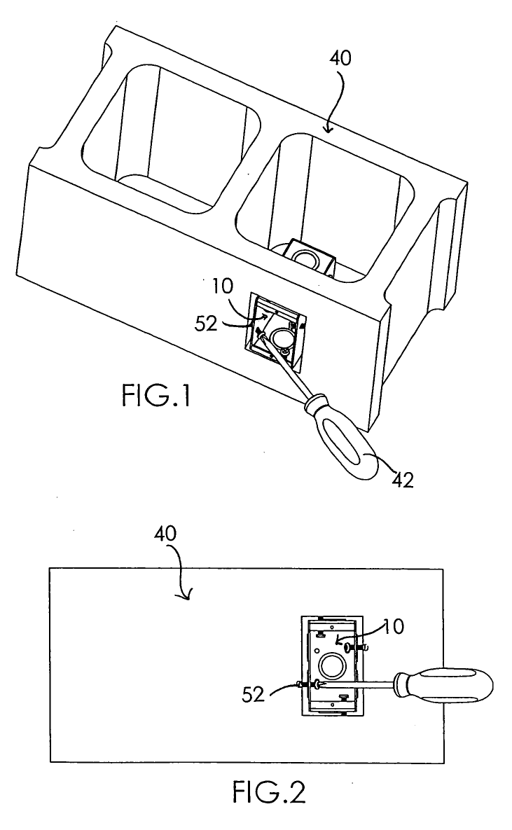

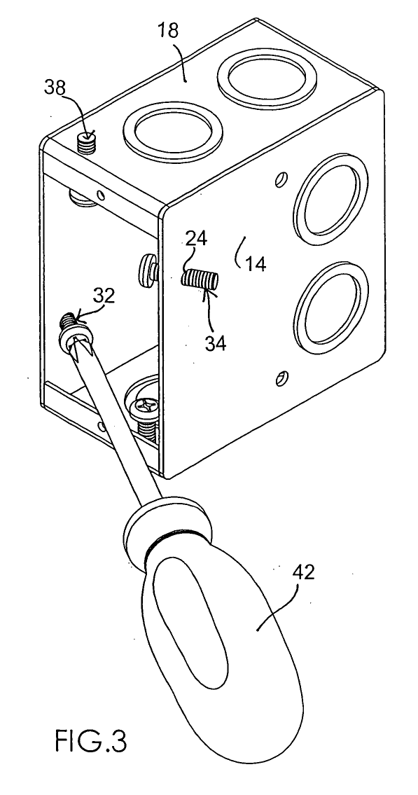

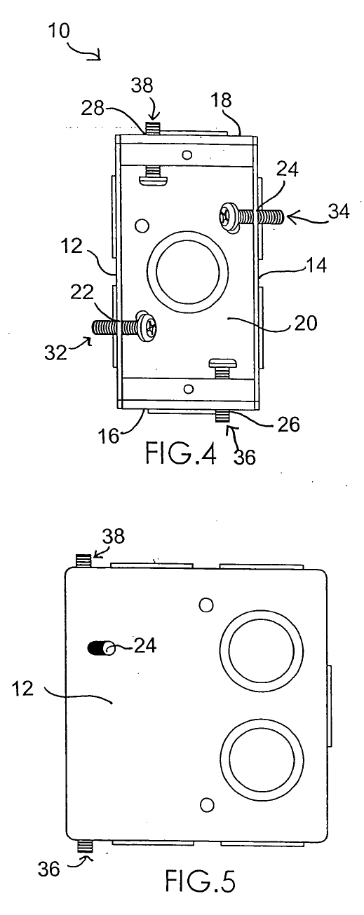

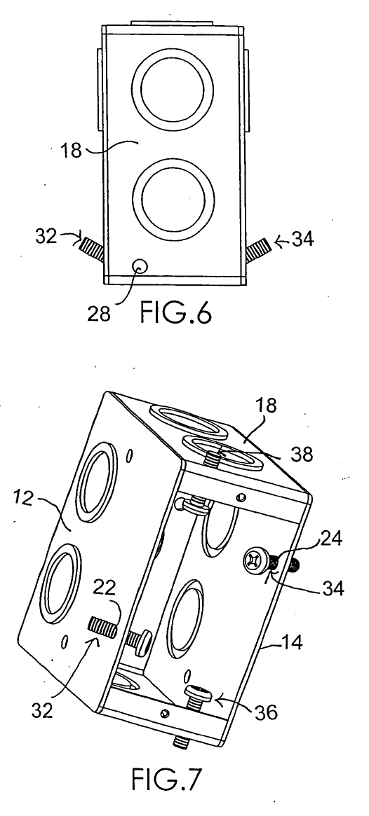

### DESCRIPTION OF THE PREFERRED EMBODIMENTS

The preferred embodiment is an electrical box 10 with screws 22, 24, 26, 28, the electrical box being inserted into a masonry brick 40. The electrical box 10 has a left side 12, a right side 14, a bottom 16, a top 18, and a rear side 20, all of which are made of metal sheets, preferably steel. The bottom 16, top 18, and rear side 20 are preferably bent out of a single metal sheet. The left side 12, and right side 14 have a left hole 22 and a right hole 24, respectively. The left hole 22 and right hole 24 are threaded to support screws, and are preferably threaded with two revolutions, which is sufficient to support the screws; more than two revolutions are difficult to create in a sheet of metal. A left screw 32 and right screw 34 are inserted into the left hole 22 and right hole, respectively. This combination of elements allows the hole in the masonry brick 40 to be cut approximately an eighth of an inch wider than the electrical box 10. The mason then adjusts the extension of the left screw 32 and right screw 34 so that they press into the masonry brick 40, creating a friction fit which will prevent the electrical box 10 from sliding out of the masonry wall 40 after the concrete that has been poured behind the electrical box expands.

If the point of contact between the left screw 32 or right screw 34 and the masonry brick 40 is too close to the face of the masonry brick 40, the pressure between them will cause the masonry brick 40 to chip along the corner of the face and the hole near the point of contact. Thus, it is desirable to move the left hole 22 and right hole 24 back away from the front of the electrical box 10. However, moving the left hole 22 and right hole 24 back with the left screw 32 and right screw 34 extending perpendicularly from the left side 12 and right side 14 makes it difficult to reach the left screw 32 and right screw 34 with a screwdriver 42. To solve this problem, the inventor has the left hole 22 and right hole 24, and therefore the left screw 32 and right screw 34, angle away from the normal to the left side 12 and right side 14, and toward the front of the electrical box 10 at an angle. This allows the left hole 22 and right hole 24 to be set further back from the front of the electrical box 10 and still allow the left screw 32 and right screw 34 to be reached by a screwdriver. It also causes the left screw 32 and right screw 34 to contact the masonry wall 40 at a point farther away from the face of the masonry wall 40 than the left hole 22 and right hole 24. The preferred angle from the normal is thirty degrees; however, the point of contact between the left screw 32 and right screw 34 and the masonry wall 40 will be sufficiently far away from the face of the masonry wall to prevent chipping if the angle is at least ten degrees.

In order to further secure the electrical box 10 into the mason block 40, the inventor prefers to drill two small apertures 52, 54, at the points of contact between the left screw 32 and right screw 34 and the masonry brick 40, before installing the left screw 32 and right screw 34. Thus, after installing the electrical box 10 into the masonry block 40, but before installing the left screw 32 and right screw 34 into the left hole 22 and right hole 24, the mason will insert an electrical drill through the left hole 22 and right hole 24 and use the electrical drill to drill a left aperture 52 and right aperture 54 at the points of contact between the left screw 32 and right screw 34 and the masonry brick 40. These apertures 52, 54, will preferably be one-eighth of an inch deep, but will serve their purpose as long as they are at least one-sixteenth of an inch deep. After the left screw 32 and right screw 34 are installed, they will extend into the left aperture 52 and right aperture 54. This will result in a tighter fit of the electrical box 10 into the masonry brick 40.

The inventor also prefers to have a bottom hole 26 and top hole 28 in the bottom 16 and top 18 which receives a bottom screw 36 and top screw 38. The bottom screw 36 and top screw 38 enable the mason to cut the hole in the masonry brick 40 taller than the electrical box 10, and adjust the extension of the bottom screw 36 and top screw 38 to fit the size of the hole in the masonry brick 40. The bottom hole 26 and top hole 28 are also threaded to receive the bottom screw 36 and top screw 38. However, the bottom screw 36 and top screw 38 are generally not used for friction fitting the electrical box 10 into the hole in hole in the masonry wall. Therefore, it will not be necessary for there to be a great amount of pressure between the bottom screw 36 and top screw 38, and these screws will not cause the masonry wall 40 to chip even if they are close to the face of the masonry wall 40. It is therefore not necessary for the bottom screw 36 and top screw 38 to be installed at angles away from the normal to the bottom 16 and top 18.

The inventor prefers to use set screws for the left screw 32, right screw 34, bottom screw 36, and top screw 38, because they are less likely than pointed screws to bend when pressed against the masonry brick 40.

Although this invention has been described above with reference to particular means, materials and embodiments, it is to be understood that the invention is not limited to these disclosed particulars, but extends instead to all equivalents within the scope of the following claims.

I claim:

1. An electrical wall box comprising:
a left side with a left hole threaded to support a left screw at a first angle which is at least ten degrees from an angle which is normal to the left side;
the left screw inserted into the left hole;
a right side with a right hole threaded to support a right screw at a second angle which is at least ten degrees from an angle which is normal to the right side;
the right screw inserted into the right hole;
a bottom side; and
a top side;
wherein the left side, right side, bottom side, and top side comprise one or more metal sheets.

2. The electrical box of claim 1 wherein the electrical box is inserted into a hole in a masonry brick.

3. The electrical box of claim 2 wherein the masonry brick comprises:
a first small aperture at a first point of contact between the masonry brick and the left screw; and
a second small aperture at a second point of contact between the masonry brick and the right screw.

4. The electrical box of claim 1 further comprising:
a bottom hole in the bottom side;
wherein the bottom hole is threaded to support a bottom screw; and
the bottom screw inserted into the bottom hole.

5. The electrical box of claim 2 further comprising:
a bottom hole in the bottom side;
wherein the bottom hole is threaded to support a bottom screw; and
the bottom screw inserted into the bottom hole.

6. The electrical box of claim 3 further comprising:
a bottom hole in the bottom side;
wherein the bottom hole is threaded to support a bottom screw; and
the bottom screw inserted into the bottom hole.

7. The electrical box of claim 6 further comprising:
a top hole in the top side;
wherein the top hole is threaded to support a top screw; and
the top screw inserted into the top hole.

8. A method for installing an electrical box into a masonry brick, the method comprising:
cutting a hole into the masonry brick wider than a distance between a left side and a right side of the electrical box; and
driving a left screw through a left hole in the left side at an angle of at least ten degrees from a first angle normal to the left side and driving a right screw through a right hole in the right side at an angle of at least ten degrees from a second angle normal to the right side to create a friction fit between the electrical box and the masonry brick.

9. The method of claim 8 further comprising drilling a left aperture into the masonry brick at a first point of contact between the masonry brick and the left screw and drilling a right aperture into the masonry brick at a second point of contact between the masonry brick and the right screw.
